(19) United States
(12) Patent Application Publication
(10) Pub. No.: US 2008/0314990 A1
(43) Pub. Date: Dec. 25, 2008

(54) Chip Card and Method For the Production of a Chip Card

(75) Inventor: Manfred Rietzler, Marktoberdorf (DE)

Correspondence Address: PROSKAUER ROSE LLP, ONE INTERNATIONAL PLACE, BOSTON, MA, 02110, US

(73) Assignee: SMARTRAC IP B.V., aMSTERDAM (NL)

(21) Appl. No.: 12/096,006

(22) PCT Filed: Nov. 30, 2006
(86) PCT No.: PCT/DE06/02126

§ 371 Date: Jun. 3, 2008

(30) Foreign Application Priority Data
Dec. 5, 2005 (DE) 10 2005 058 101.3

(51) Int. Cl. G06K 19/06

(52) U.S. Cl. 235/492; 29/601

(57) ABSTRACT

The invention pertains to a chip card and to a method for producing a chip card with a chip module that is contacted with an external contact arrangement arranged in the contact surface of a card body, as well as with an antenna device arranged in a card inlay, wherein the card inlay is initially produced in a first production device and the card inlay is subsequently provided with at least one respective external layer on both sides in a second production device, namely in such a way that the external contact arrangement arranged on the external contact side of the chip carrier is introduced into a recess of the assigned external layer, and wherein a connection between the card inlay and the external layers is subsequently produced in a laminating process.

### RELATED APPLICATIONS

This application is the U.S. National stage of International Application No. PCT/DE2006/002126, filed on Nov. 30, 2006, published in German, which claims priority to German Patent Application No. 10 2005 058 101.3, filed on Dec. 5, 2005. The entire teachings of the above applications are incorporated herein by reference.

### FIELD OF THE INVENTION

The present invention pertains to a chip card with a chip module that is contacted with an external contact arrangement arranged in the contact surface of a card body, as well as an antenna device arranged in a card inlay. The invention furthermore pertains to a method for the production of such a chip card.

### BACKGROUND

Chip cards of the initially cited type are also referred to as so-called “Combicards” or “Dual-Interface-Cards.” Such chip cards make it possible to access the information contained on the chip in a contacting fashion by means of the external contact arrangement arranged in the card surface, as well as in a contactless fashion by means of the antenna device that forms a transponder unit in connection with the chip.

Until now, the production of such chip cards has proved very complex because the recess required for accommodating the chip module in the card body is typically produced with an abrasive material processing method such as, for example, milling in order to ensure that the chip module provided with the external contact arrangement is arranged within the card body in such a way that it securely contacts the antenna device situated in the interior of the card body. On the other hand, the external contact arrangement needs to be arranged flush in the contact surface of the card body in order to ensure a trouble-free operation of the card.

Regardless of whether the card body is produced by means of a molding process or in the form of a laminate consisting of a plurality of layers that are connected to one another in a laminating process, the subsequent production of the recess in the card body for accommodating the chip module in the card body requires an additional processing step based on the production of the card body. Furthermore, the contacting between the antenna device and the chip module in thusly designed chip cards needs to be realized in a concealed fashion in the form of a rear surface contact subsequent to the implementation of the chip module.

### SUMMARY OF THE INVENTION

The present invention is based on the objective of proposing a chip card that is suitable for a contacting and for a contactless operation, as well as a method for the production thereof, which allows a significantly simplified production of the chip card.

According to the invention, the chip card features a card inlay with at least two layers, namely a receptacle layer that is provided with a recess for partially accommodating the chip module and a cover layer that covers the chip module on one side. The card inlay of the inventive chip card is provided with at least one respective external layer on both sides, wherein the recess serves for accommodating a chip housing arranged on an internal contact side of a chip carrier of the chip module and the cover layer defines a bottom of the recess. In this case, the external contact arrangement arranged on the external contact side of the chip carrier forms a layer projection that protrudes from the plane of the receptacle layer and is accommodated in a recess of the external layer in such a way that the external contact arrangement is arranged flush with the contact surface of the card body.

The design of the inventive chip card therefore is based on a card inlay, from which the external contact arrangement of the chip module protrudes such that an altogether flush arrangement of the external contact arrangement in the card body can be easily achieved by applying an external layer, the thickness of which corresponds to the layer projection formed by the external contact arrangement. Since the card inlay is designed with at least two layers, namely a receptacle layer and a cover layer that accommodate the antenna device between one another, and since the internal contact side of the chip carrier is accessible through the recess of the receptacle layer, the contacting points for contacting the chip module with the antenna device are freely accessible such that a secure contacting between the chip module and the antenna device can be realized and checked with respect to its quality. In contrast to conventional chip cards of the generic type that are designed as described above, the contacting therefore no longer has to be realized in a concealed fashion in the form of a rear surface contact, but rather can be achieved by directly acting upon the contacting point.

The inventive card inlay features at least two layers, namely a receptacle layer that is provided with a recess for partially accommodating the chip module and a cover layer that covers the chip module on one side, wherein these two layers accommodate the antenna device between one another. The recess for accommodating a chip housing arranged on an internal contact side of a chip carrier of the chip module makes it possible to freely access the contacting points between the internal contacts arranged on the internal contact side of the chip carrier and the antenna device prior to the application of the cover layer. A bottom of the recess can be defined only after the contacting by applying the cover layer such that only the external contact arrangement arranged on the external contact side of the chip carrier forms a layer projection of the card inlay that protrudes from the plane of the receptacle layer. During the subsequent finishing of the chip card, this projection can be accommodated in a flush fashion by an external layer that is provided with a corresponding recess, wherein the layer projection simultaneously forms a positioning aid for the relative positioning of the external layer on the card inlay.

An exactly defined relative positioning between the internal contact side of the chip carrier and the antenna device arranged in the card inlay can be achieved if the substrate for the antenna device is formed by the receptacle layer itself.

With respect to a secure relative positioning of the chip module in the card inlay, it is particularly advantageous if the chip housing of the chip module is provided with an adhesive coating on its upper side that faces the cover layer. This ensures that the chip module is fixed in the recess of the card inlay after the cover layer has been applied on the chip housing regardless of the contacting with the antenna device.

In this context, it is particularly advantageous if the adhesive coating consists of a hot-melt adhesive mass because this adhesive mass is activated by subjecting the hot-melt adhesive to a corresponding temperature during a laminating process such that the adhesive effect is not impaired by the laminating process, but rather promoted.

If the adhesive coating is furthermore realized in the shape of a band, the adhesive mass can be very easily handled and adapted to the contour of the chip housing during the production of the card inlay.

If a pressure-sensitive adhesive is additionally provided on the band-shaped adhesive coating, the adhesive coating is securely fixed on the chip housing prior to the laminating process by means of the pressure-sensitive adhesive and a permanent, secure connection between the chip module and the card inlay is produced by means of the hot-melt adhesive mass that is subsequently activated during the laminating process.

In the inventive method, a card inlay is initially produced in a first production device. Subsequently, the card inlay is provided with at least one respective external layer on both sides in a second production device, namely in such a way that the external contact arrangement arranged on the external contact side of the chip carrier is introduced into a recess of the assigned external layer. Subsequently, the card inlay is connected to the external layers in a laminating process.

The inventive method therefore makes it possible to produce a chip card of the generic type based on a card inlay and two independent production devices such that the card inlay can be handled as a semi-finished product that is produced at a first production site and subsequently finished in a second production process that is completely independent of the first production process and is carried out in a second production device that may be arranged distant of the first production device. The card inlay therefore can be delivered to a card manufacturer in the form of a semi-finished product for further processing and/or finishing a chip card.

It is particularly advantageous if the production of the card inlay in the first production device begins by positioning the chip module in a recess of a laminator plate in such a way that an external contact arrangement arranged on an external contact side of a chip carrier of the chip module is accommodated in the recess of the laminator plate and a chip housing arranged on an internal contact side of the chip carrier protrudes from the recess of the laminator plate. Subsequently, a receptacle layer that is preferably realized in the form of a substrate of an antenna device is arranged on the laminator plate in such a way that the chip housing is introduced into a recess of the receptacle layer, wherein the antenna device is arranged on the surface of the substrate that faces away from the laminator plate. Consequently, the antenna device can be subsequently contacted with the internal contact side of the chip carrier due to the freely accessible internal contacts of the chip carrier before the cover layer is arranged on the receptacle layer in order to cover the contacting points. The subsequent production in a laminate between the receptacle layer and the cover layer therefore produces a permanently sealed arrangement of the chip housing arranged on the chip carrier and of the internal contact side of the chip carrier in the card inlay such that the additional storage and handling of the card inlay prior to the finishing of the chip card at the card manufacturer by laminating on the external layers can be realized in a completely unproblematic fashion and without special precautions such as, for example, a special protective packaging of the card inlay.

In order to produce the chip card in the second production device, the card inlay is preferably provided with at least one respective external layer on both sides, wherein the external contact arrangement arranged on the external contact side of the chip carrier is introduced into a recess of the assigned external layer. Subsequently, a laminate between the external layer and the card inlay is produced in such a way that a flush-surface arrangement of the external contact arrangement with the contact surface of the card body formed due to the production of the laminate is adjusted.

### BRIEF DESCRIPTION OF THE DRAWINGS

Preferred embodiments of the chip card and the card inlay, as well as of the method for the production of the chip card, are described in greater detail below with reference to the figures.

FIG. 1 is a layer arrangement for producing a card inlay in a laminating device.

FIG. 2a is a side view of a chip module accommodated in a recess of a laminator plate.

FIG. 2b is a top view of the chip module illustrated in FIG. 2a.

FIG. 3a is a side view of the chip module arranged in a receptacle layer.

FIG. 3b is a top view of the chip module illustrated in FIG. 3a.

FIG. 4a is a side view of the chip module that is covered by a cover layer and arranged between two laminator plates.

FIG. 4b is a top view of the chip module illustrated in FIG. 4a.

FIG. 5 is a partial illustration of a card inlay sheet with a plurality of connected card inlays.

FIG. 6 is a top view of the card inlay sheet illustrated in FIG. 5.

FIG. 7 is a layer arrangement composed of a card inlay sheet and a plurality of external layer sheets in order to produce a chip card in a laminator arrangement.

FIG. 8 is a partial illustration of a chip card sheet with a plurality of connected chip cards.

### DETAILED DESCRIPTION

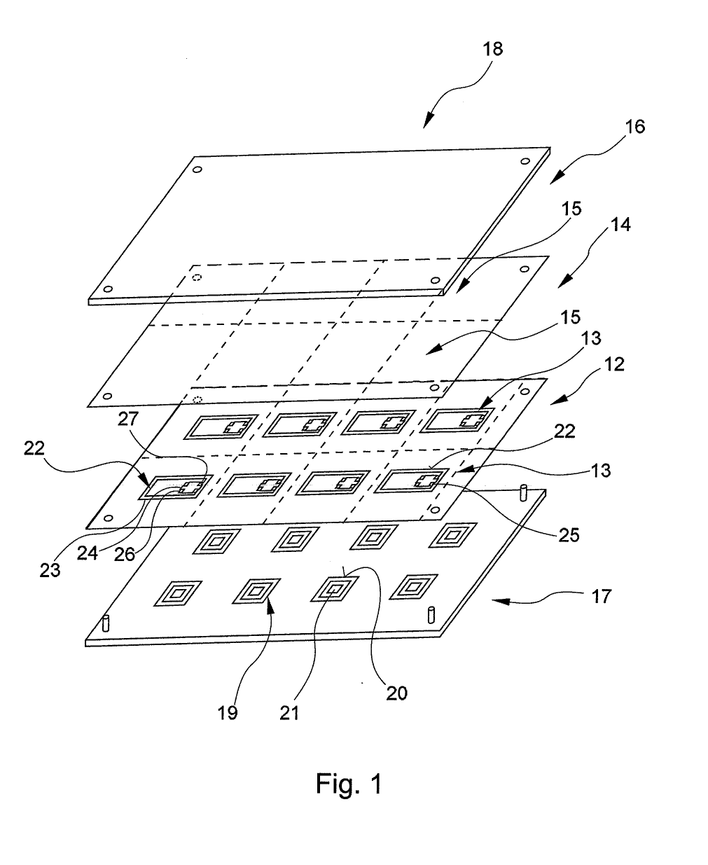

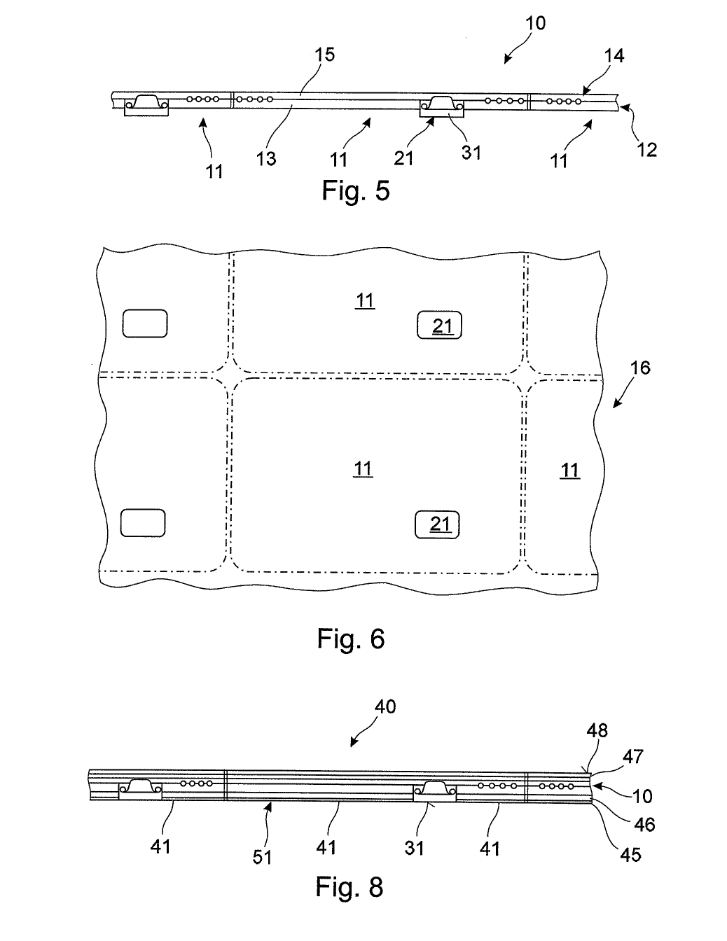

FIG. 1 shows an arrangement of a plurality of so-called panel sheets that respectively feature a plurality of layers interconnected in one piece in the form of a panel arrangement in order to produce a card inlay sheet 10 according to FIG. 5 with a plurality of interconnected card inlays 11. FIG. 1 specifically shows a receptacle layer sheet 12 with a plurality of interconnected receptacle layers 13 and a cover layer sheet 14 with a plurality of interconnected cover layers 15.

The receptacle layer sheet 12 and the cover layer sheet 14 are situated between a lower laminator plate 17 and an upper laminator plate 18 of a laminator arrangement 16. The lower laminator plate 17 is provided with an arrangement 19 of recesses 20 corresponding to the panel arrangement of the receptacle layer sheet 12 and serving for accommodating a corresponding number of chip modules 21.

The receptacle layers 13 of the receptacle layer sheet 12 respectively serve as antenna substrates, on which one respective antenna device 22 with several antenna windings 23 is arranged, namely in the form of a wire arrangement in the example shown. The antenna devices 22 respectively feature two contact ends 24, 25 that extend over contacting bays 26 in an opening edge 27 of a recess 28.

The receptacle layer sheet 12, as well as the cover layer sheet 14, consists of a plastic material that can be laminated such as, for example, polyethylene or PVC.

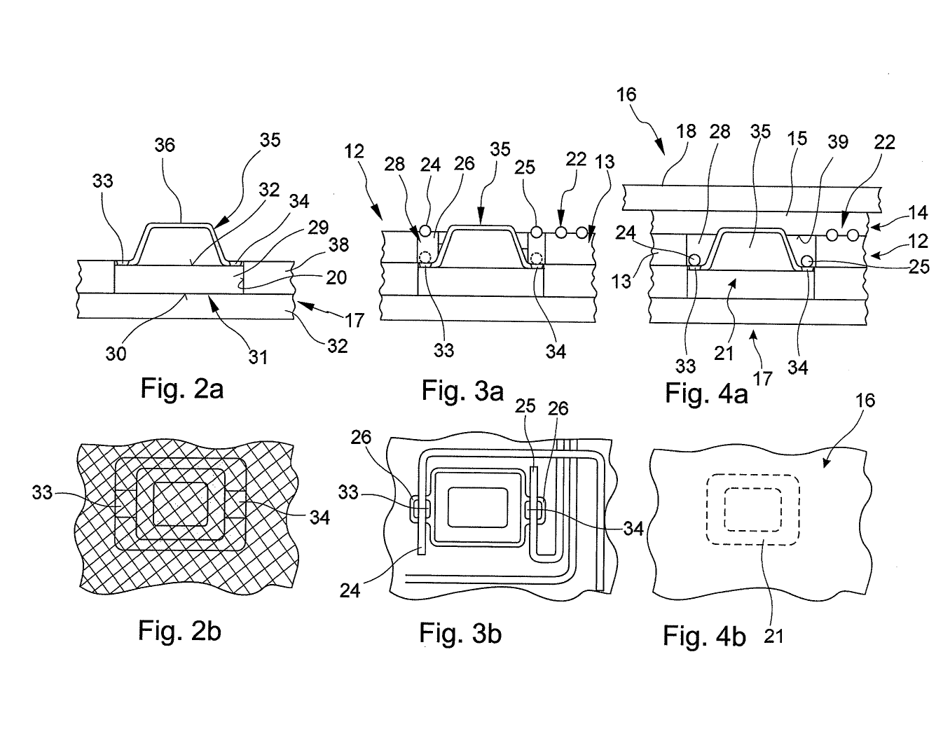

The structure of the layer arrangement according to FIG. 1 for producing the card inlay sheet 10 is described in greater detail below with reference to FIGS. 2 to 4. FIG. 2a shows a chip module 21 that is accommodated in a recess 20 of the laminator plate 17 and features a chip carrier 29 with an external contact surface arrangement 31 on an external contact side 30 and internal contacts 33, 34 that serve for contacting the contact ends 24, 25 of the antenna device 22 (FIG. 1) on an internal contact side 32.

According to an overall view of FIGS. 2a and 2b, a chip housing 35 that is arranged on the internal contact side 32 of the chip carrier 29 and serves for accommodating a not-shown chip is provided with an adhesive band 36 that essentially consists of a hot-melt adhesive mass that is provided with a pressure-sensitive adhesive coating on its side that faces the chip housing 35.

In addition, FIG. 2a clearly shows that the laminator plate 17 consists of two layers in the example shown, namely a ceramic base layer 37 and a metal layer 38 that is arranged on the base layer and contains the recesses 20.

The receptacle layer sheet 12 is subsequently arranged on the laminator plate 17 illustrated in FIG. 1 with the chip modules 21 accommodated in the recesses 20 of the laminator plate 17 in such a way that the chip modules 21 protrude into the recesses 28 of the receptacle layers 13 with their housings 35 as illustrated in FIG. 3a.

An overall view of FIGS. 3a and 3b shows that, in this configuration, the contact ends 24, 25 of the antenna device 22 arranged on the receptacle layer 13 extend directly above the internal contacts 33, 34 of the chip module 21. In this configuration, a not-shown, ram-shaped contacting tool can be used for contacting the contact ends 24, 25 with the internal contacts 33, 34 of the chip module 21 in the recess 28 and/or the contacting bays 26 from above under the influence of pressure and heat.

FIG. 4a shows the contact ends 24, 25 of the antenna device 22 that are contacted with the internal contacts 33, 34, as well as the cover layer sheet 14 that is arranged on the receptacle layer sheet 12 subsequent to the contacting process, wherein the cover layer sheet features the cover layers 15 that are formed therein and are respectively arranged on the chip module 21 and the chip housing 35 and thusly form a bottom 39 of the recess 28.

In the configuration shown in FIGS. 4a and 4b, the chip module 21 is accommodated in the laminator arrangement 16 such that it is covered on both sides, wherein the layer arrangement arranged between the laminator plate 17 and the laminator plate 18 that preferably consists entirely of metal is now acted upon with pressure and heat in order to form a laminate between the receptacle layer sheet 12 and the cover layer sheet 14 for the production of the card inlay sheet 10 illustrated in FIG. 5.

The card inlay sheet 10 that is illustrated in FIGS. 5 and 6 and features a plurality of interconnected card inlays 11 as illustrated, in particular, in the bottom view according to FIG. 6 is now used for producing a chip card sheet 40 that is illustrated in the form of a sectional representation in FIG. 8 and features a corresponding number of interconnected chip cards 41.

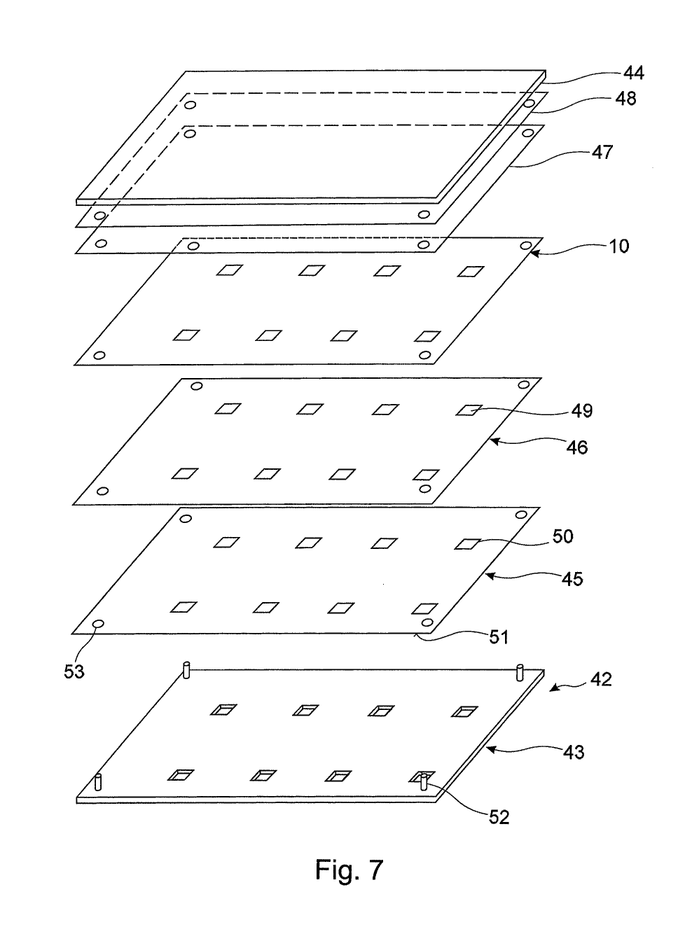

According to FIG. 7, the chip card sheet 40 is produced in a laminator arrangement 42 that features a lower laminator plate 43 and an upper laminator plate 44 by connecting external layer sheets 45, 46 and 47, 48 that are respectively arranged on one side of the card inlay sheet 10 to the card inlay sheet 10 in another laminating process.

FIG. 7 furthermore shows that the external contact arrangements 31 of the chip modules 21 that are arranged on the underside of the card inlay sheet 10 and protrude from the receptacle layer sheet 12 (FIG. 5) form layer projections that serve as positioning aids for positioning the external layer sheets 45, 46 relative to the card inlay sheet 10 in cooperation with correspondingly realized recesses 49, 50 in the external layer sheets 45, 46. In this case, the external layer sheets 45, 46 are realized so thick that the production of a laminate between the layers 45, 46, 10, 47 and 48 in the laminator arrangement 42 results in a flush-surface arrangement of the external contact arrangement 31 in a contact surface of the chip cards 41 that is defined by the external layer sheet 45.

The external layer sheets 47 and 48 are realized in a closed fashion and preferably have a thickness that corresponds to the respective thickness of the external layer sheets 45, 46. The external layer sheets 45 to 48 that are applied in another production device, for example, at a card manufacturer may consist, for example, of printed external layer sheets 46 and 47 that are respectively covered with an additional external layer 45, 48 in the form of a protective foil layer.

In order to ensure the correct relative positioning between the individual layers 45, 46, 10, 47 and 48 illustrated in FIG. 7 for the laminating process, it would be possible, for example, to provide the lower laminator plate 43 with positioning pins 52 that engage into corresponding positioning recesses 53 of the layers 45, 46, 10, 47 and 48. Since the production of the chip card sheets 40 in the laminator arrangement 42 is carried out based on the card inlay sheet 10 produced in the laminator arrangement 16 (FIG. 1), the positioning can be realized in accordance with the positioning grid of the laminator plate 17 of the laminator arrangement 16 formed by the arrangement 19 of the recesses 20. Consequently, it would also be possible, in principle, to utilize the same laminator plate 17 for carrying out the laminating process shown in FIG. 7 as in the laminating process according to FIG. 1 for producing the card inlay sheet 10. In this case, the recesses 20 in the laminator plate 17 and the laminator plate 43 ensure that the external contact arrangements 31 are not subjected to a direct thermal stress during the production of the chip card sheet 40.

After the chip card sheet 40 is finished, the interconnected chip cards 41 of the panel arrangement can be separated into individual chip cards.

1. (canceled)

2. (canceled)

3. The card inlay according to Claim 12, wherein the receptacle layer is a substrate having a surface on which an antenna device is arranged.

4. The card inlay according to Claim 12 wherein the chip housing of the chip module is provided with an adhesive coating on its upper side that faces the cover layer.

5. The card inlay according to Claim 4, wherein the adhesive coating comprises a hot-melt adhesive mass.

6. The card inlay according to Claim 4, wherein the adhesive coating is an adhesive band.

7. The card inlay according to Claim 6, wherein the adhesive band comprises a pressure-sensitive adhesive coating.

8.-10. (canceled)

11. A chip card having a card body comprising:
a chip module that comprises a chip carrier having an external contact side and an internal contact side, a chip housing arranged on the internal contact side of the chip carrier, and an external contact arrangement arranged on the external contact side of the chip carrier;
an antenna device;
a card inlay comprising a receptacle layer and a cover layer, the receptacle layer defining a recess, the cover layer defining a bottom of the recess, the antenna device being arranged in the card inlay;
at least one external layer being positioned on both sides of the card inlay; and
the chip module being partially accommodated within the recess of the receptacle layer, such that the chip housing is accommodated within the recess and the external contact arrangement forms a layer projection that protrudes from a surface plane of the receptacle layer, the external contact arrangement being accommodated in a recess of the at least one external layer adjacent the receptacle layer such that the external contact arrangement is flush with a contact surface of the card body.

12. A card inlay for producing a chip card comprising:
a chip module that comprises a chip carrier having an external contact side and an internal contact side, a chip housing arranged on the internal contact side of the chip carrier, and an external contact arrangement arranged on the external contact side of the chip carrier;
a card inlay comprising a receptacle layer and a cover layer, the receptacle layer defining a recess, the cover layer defining a bottom of the recess, the antenna device being arranged in the card inlay; and
the chip module being partially accommodated within the recess of the receptacle layer, such that the chip housing is accommodated within the recess and the external contact arrangement forms a layer projection that protrudes from a surface plane of the receptacle layer.

13. A method for producing a chip card comprising a card body that contains a chip module, the chip module comprising a chip carrier having an external contact side and an internal contact side, a chip housing arranged on the internal contact side of the chip carrier, and an external contact arrangement arranged on the external contact side of the chip carrier, the method comprising the steps of:
positioning the chip module in a recess of a laminator plate such that the external contact arrangement is accommodated within the recess and the chip housing protrudes from the recess;
arranging a receptacle layer on the laminator plate such that the chip housing is introduced into a recess defined in the receptacle layer, the receptacle layer comprising an antenna device arranged on a surface of the receptacle layer facing away from the laminator plate;
contacting the antenna device with the internal contact side of the chip carrier;
arranging a cover layer on the receptacle layer, and
laminating the receptacle layer and the cover layer to produce a card inlay having the external contact arrangement protruding from a surface plane of the receptacle layer.

14. The method according to claim 9, further comprising:
arranging at least one external layer on both sides of the card inlay, such that the external contact arrangement protruding from the surface plane of the receptacle layer is introduced into a recess of the at least one external layer adjacent the receptacle layer of the card inlay; and
laminating the external layers and the card inlay, such that the external contact arrangement is flush with a contact surface of the card body.
